(19) United States
(12) Patent Application Publication
(10) Pub. No.: US 2011/0233914 A1
(43) Pub. Date: Sep. 29, 2011

(54) Spiral bound notebook with removable sheets

(76) Inventor: Sheng-Tan Wang, Changhua (TW)

(21) Appl. No.: 12/729,259

(22) Filed: Mar. 23, 2010

(51) Int. Cl. B42D 1/00

(52) U.S. Cl. 281/27.2

(57) ABSTRACT

A spiral bound notebook includes a plurality of sheets of paper each having a plurality of equally spaced holes adjacent one side, each hole having a slit with one open end extending to the edge of one side of the sheet of paper; and a binding mechanism having a plurality of flexible C-shaped rings connected together, each C-shaped ring including a recess on an intermediate portion prior to binding the sheets of paper. A removed sheet of paper can be intact without damage.

### BACKGROUND OF THE INVENTION

1. Field of Invention

The invention relates to spiral bound notebooks and more particularly to such a spiral bound notebook having an arrangement capable of removing sheets of paper without tearing.

2. Description of Related Art

A typical spiral bound notebook A is shown in FIGS. 1 and 2 and comprises a helical wire B looping through larger perforations A2 of sheets of paper A1. However, a plurality of cracks each extending from the perforation A2 to the edge are generated after removing a desired sheet of paper A1. This drawback is not desired. Thus, the need for improvement still exists.

### SUMMARY OF THE INVENTION

It is therefore one object of the invention to provide a spiral bound notebook comprising a plurality of sheets of paper each comprising a plurality of equally spaced holes adjacent one side, each hole including a slit with one open end extending to the edge of one side of the sheet of paper; and a binding mechanism comprising a plurality of flexible C-shaped rings connected together, each C-shaped ring including a recess on an intermediate portion prior to binding the sheets of paper.

The above and other objects, features and advantages of the invention will become apparent from the following detailed description taken with the accompanying drawings.

### BRIEF DESCRIPTION OF THE DRAWINGS

FIG. 1 is a perspective view of a typical spiral bound notebook being open;

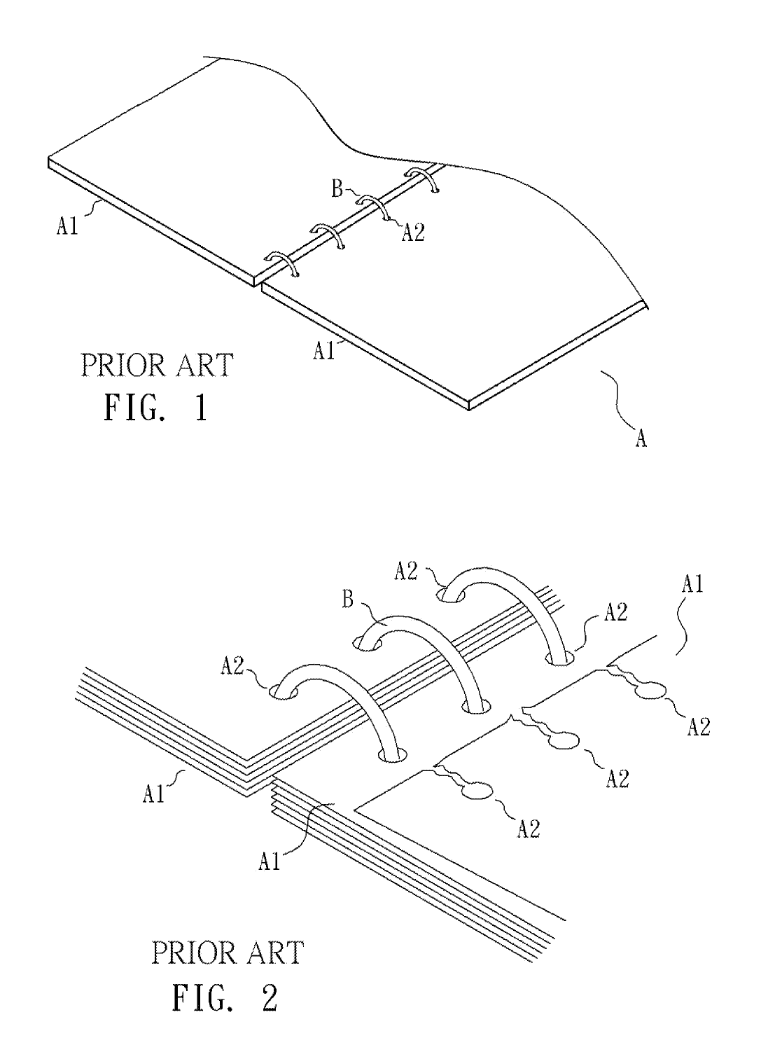

FIG. 2 is a fragmentary view of FIG. 1 showing details after removing a desired sheet of paper;

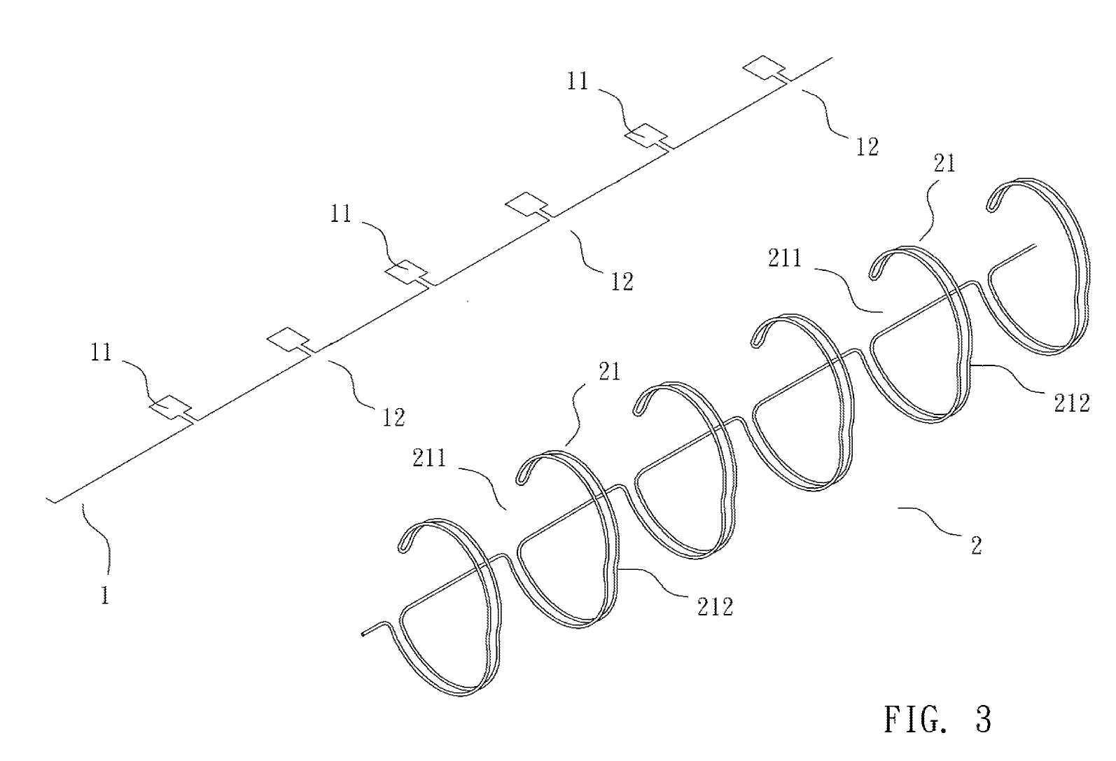

FIG. 3 is an exploded view showing the helical wire and the edge of a sheet of paper prior to binding them together according to a spiral bound notebook of the invention;

FIG. 4 shows three steps of binding sheets of paper by means of the helical wire of FIG. 3;

FIG. 5 is a perspective view of the assembled spiral bound notebook of the invention;

FIG. 6 is a fragmentary view of FIG. 5 showing a removal of a single sheet of paper from the spiral bound notebook;

FIG. 7 shows three steps of binding a sheet of paper to the spiral bound notebook of FIG. 5 and turning the sheet of paper to the top of the topmost sheet of paper by turning the notebook upside down; and

FIGS. 8, 9, 10 and 11 are perspective views each showing a portion of a sheet of paper with punched holes of different shapes to be assembled with the sheets of paper bound in the notebook of the invention.

### DETAILED DESCRIPTION OF THE INVENTION

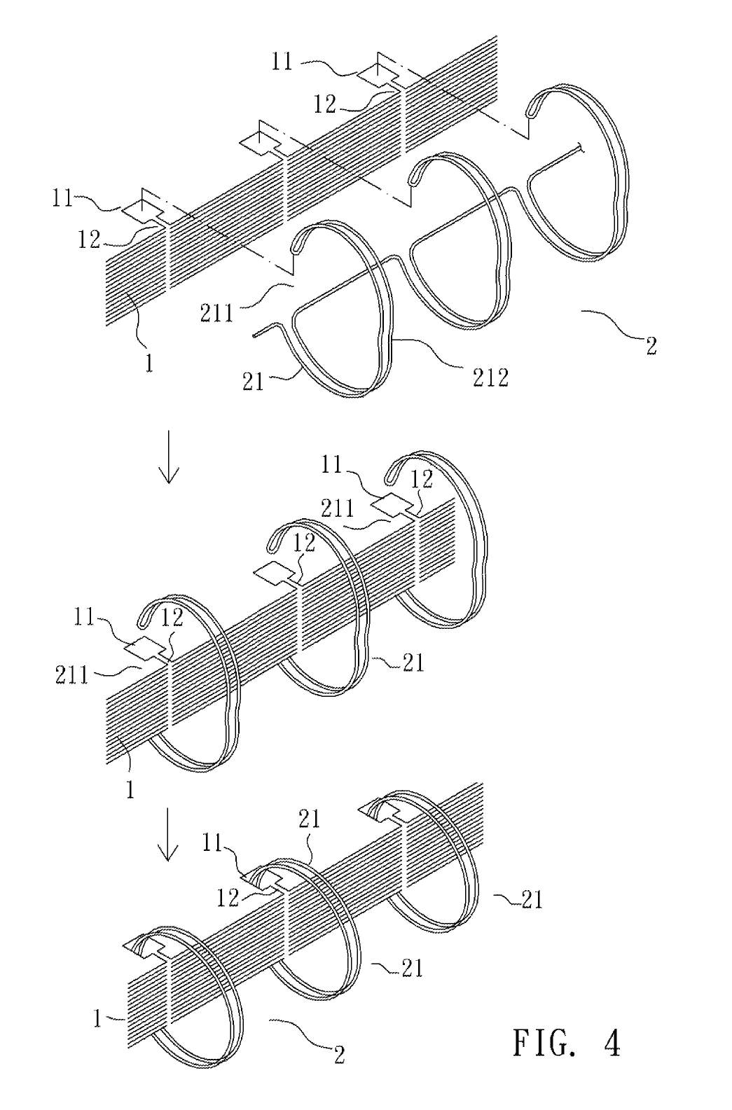

Referring to FIGS. 3 to 11, a spiral bound notebook in accordance with the invention comprises the following components as discussed in detail below.

A plurality of rectangular sheets of paper 1 each has a plurality of equally spaced, rectangular holes 11 formed by punching a straight line adjacent one side. Each hole 11 has a slit 12 having one end extending to the edge of the side.

A helical wire 2 is wound into a plurality of C-shaped rings 21 each including a small recess 212 on an intermediate portion of two opposite wire sections and an opening 211. Preferably, any two adjacent C-shaped rings 21 are spaced by one inch. The binding mechanism formed by the helical wire 2 is thus flexible and robust.

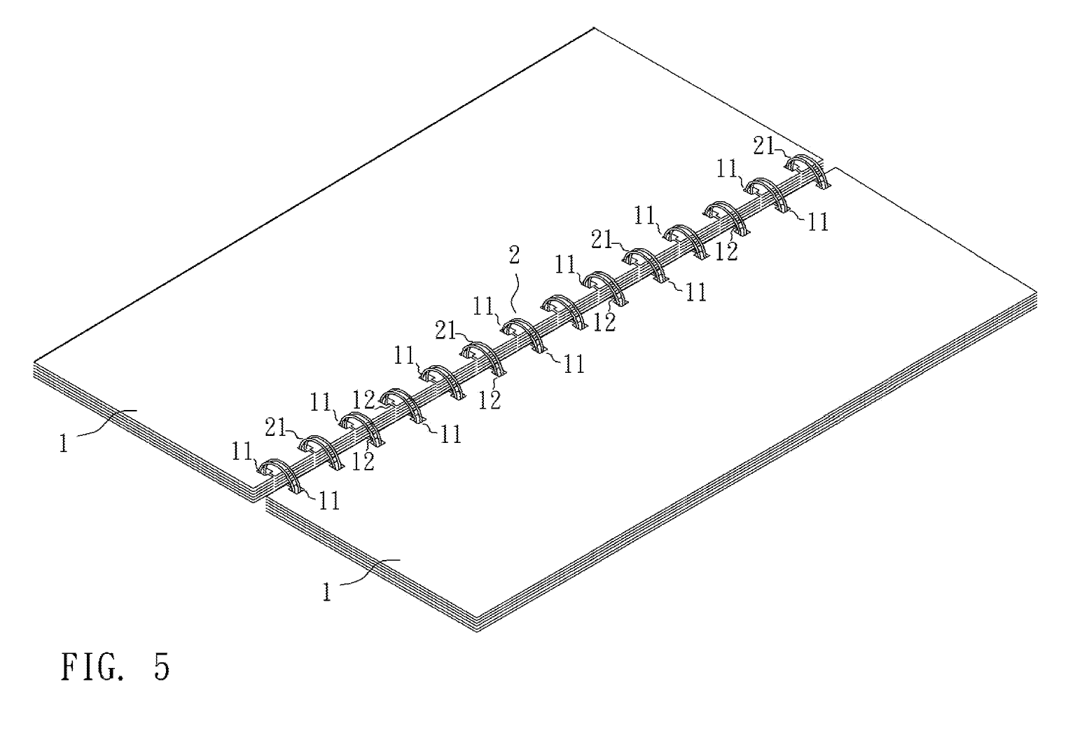

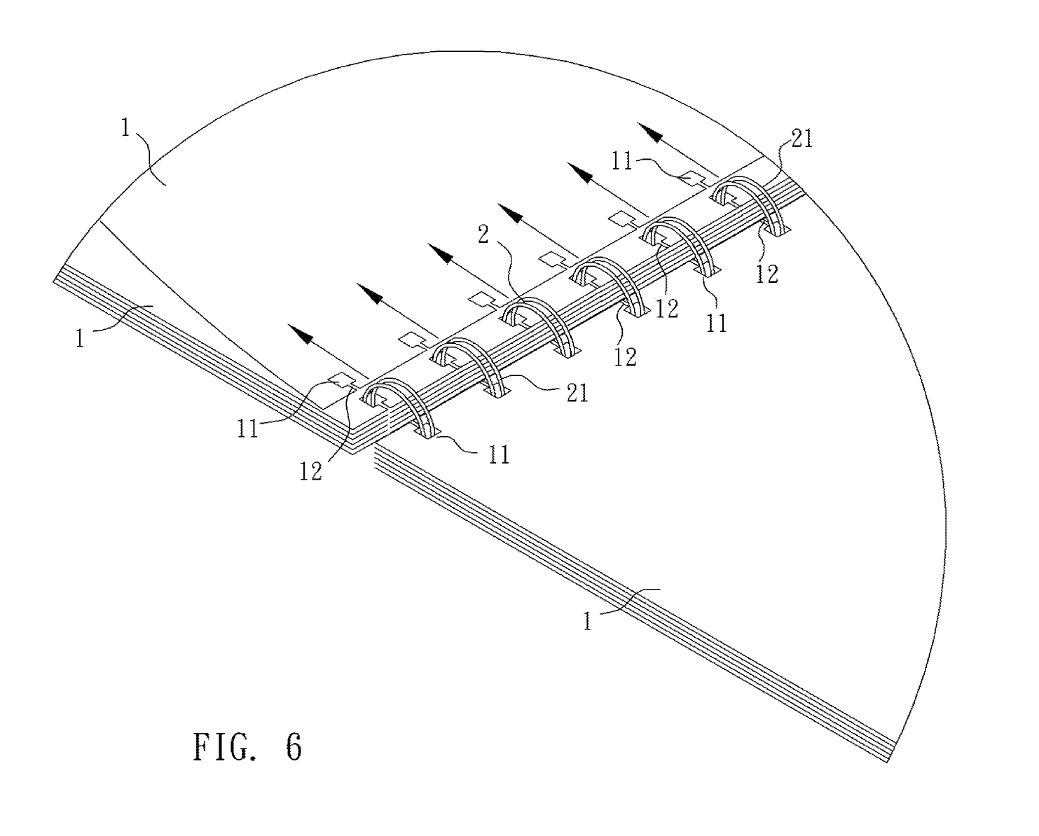

In a binding process (see FIGS. 4 and 5), a plurality of sheets of paper 1 can be stacked together. Next, an employee may align the openings 211 of the C-shaped rings 21 with the holes 11. Next, place the side of the sheets of paper 1 in the openings 211 with the tops of the openings 211 above the holes 11. Next, press the upper portions of the C-shaped rings 21 by bending the recess 212 until the a portion of each C-shaped ring 21 above the opening 211 inserts into the hole 11 to substantially close the opening 211. As such, the sheets of paper 1 are bound by bending the recesses 212 of the C-shaped rings 21. As a result, a notebook is bound.

It is noted that the width of the C-shaped ring 21 is sufficiently greater than that of the slit 12 and less than that of the hole 11. Hence, the sheets of paper 1 are lockingly bound without worrying being removed unintentionally.

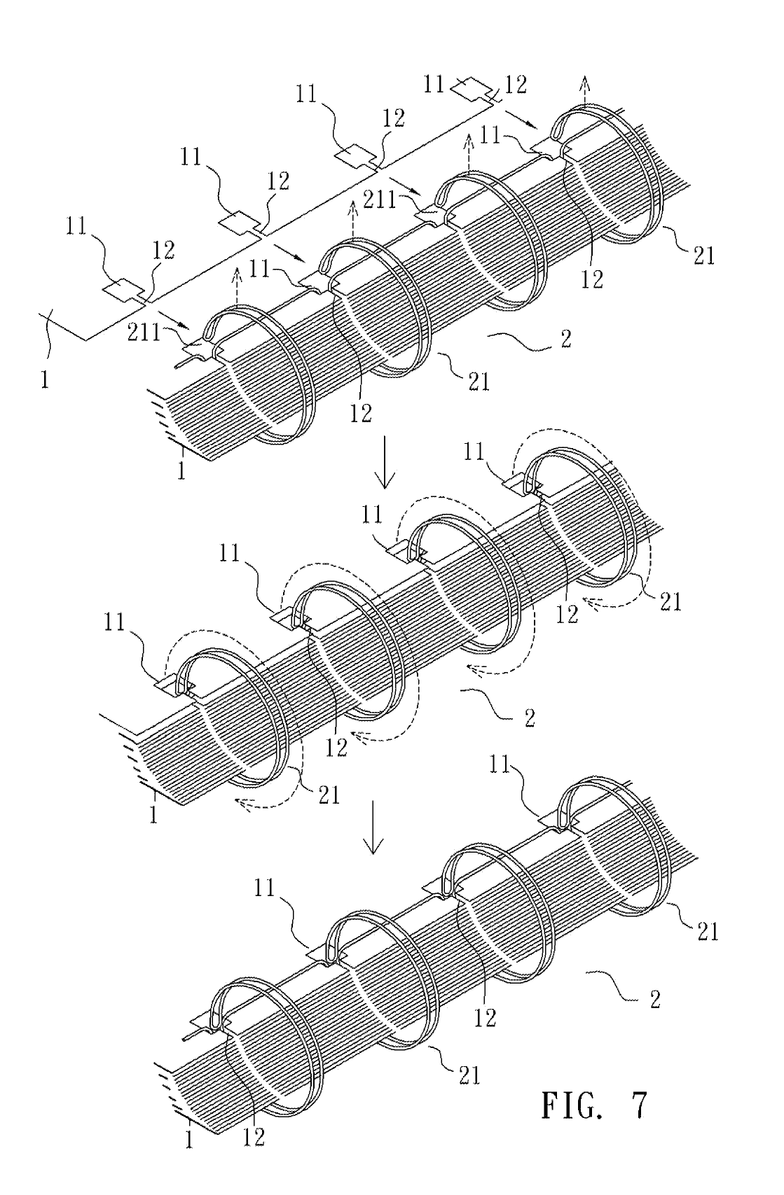

A user may turn the sheet of paper (or sheets of paper) 1 to find his or her desired page in a manner known in the art. Thereafter, the user may pull the sheet of paper 1 leftward (as indicated by arrows) to cause the holes 11 to clear the C-shaped rings 21 along the slits 12 (see FIG. 6). It is seen that the removed sheet of paper 1 is intact without damage.

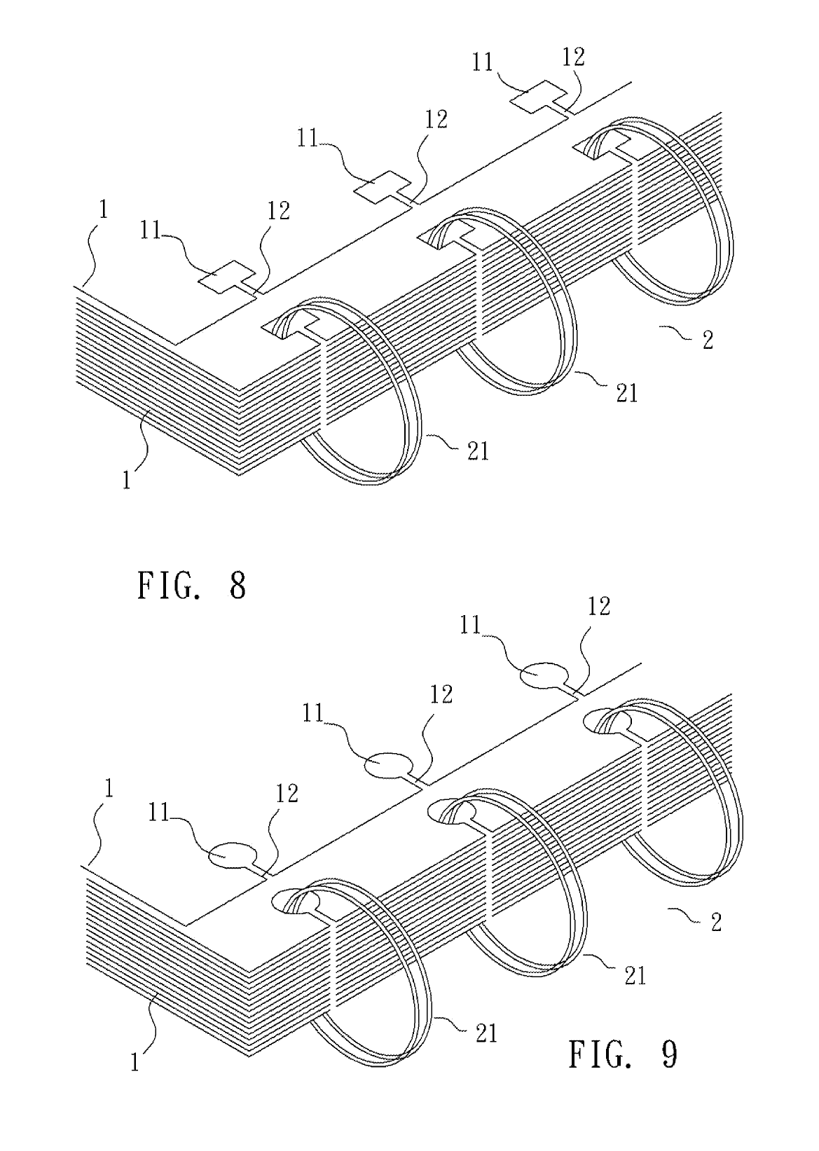

The user may bind a sheet of paper 1 to the notebook in a manner as described by referring to FIG. 7. First, turn the notebook upside down. Next, push the sheet of paper 1 toward the openings 211 of the C-shaped rings 21 as indicated by arrows in the upper part of FIG. 7. As a result, the sheet of paper 1 is bound as a portion of each C-shaped ring 21 is disposed in the hole 11. Next, turn the sheet of paper 1 about 180 degrees to the top of the topmost sheet of paper 1 as indicated by dotted arrows in the intermediate part of FIG. 7. As a result, the sheet of paper 1 is added and bound.

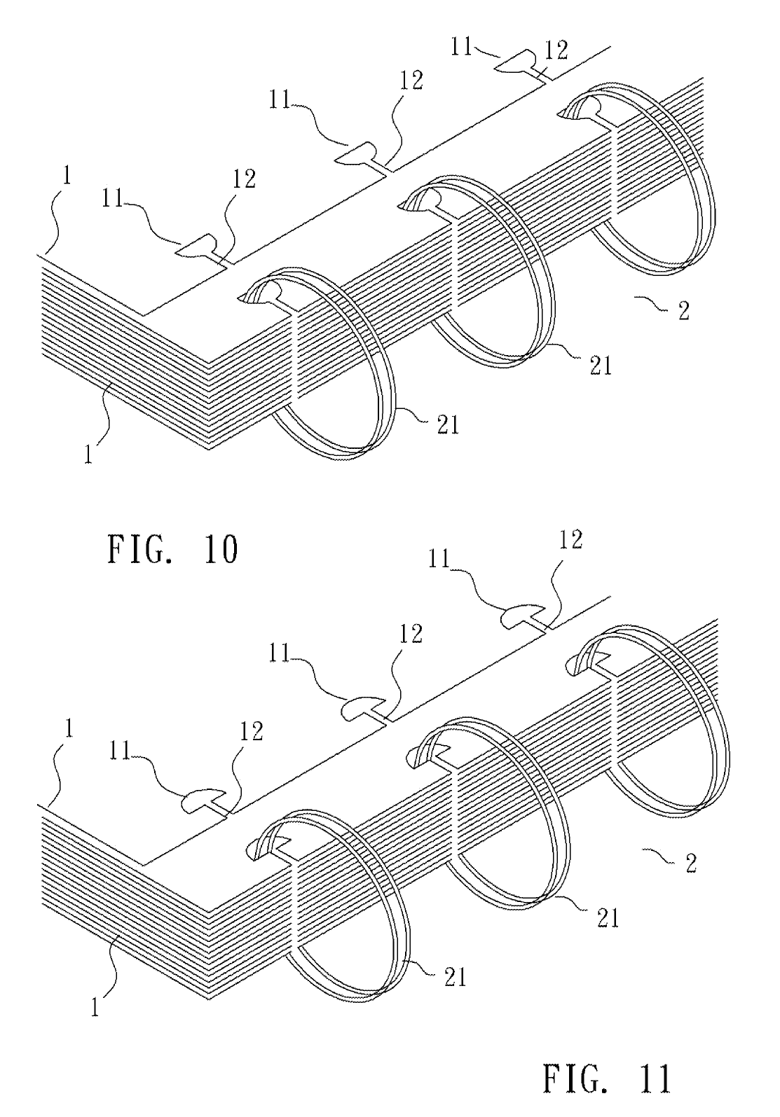

Referring to FIG. 8, the sheet of paper 1 may have a plurality of rectangular punched holes 11 each having a slit 12 extending to the edge in a first preferred embodiment.

Referring to FIG. 9, the sheet of paper 1 may have a plurality of circular punched holes 11 each having a slit 12 extending to the edge in a second preferred embodiment.

Referring to FIG. 10, the sheet of paper 1 may have a plurality of half circular punched holes 11 each having a slit 12 extending to the edge in a third preferred embodiment.

Referring to FIG. 11, the sheet of paper 1 may have a plurality of half circular punched holes 11 each having a slit 12 extending to the edge in a fourth preferred embodiment but the orientation of each hole 11 is opposite to the that of the hole 11 shown in the third preferred embodiment.

While the invention herein disclosed has been described by means of specific embodiments, numerous modifications and variations could be made thereto by those skilled in the art without departing from the scope and spirit of the invention set forth in the claims.

What is claimed is:

1. A spiral bound notebook comprising:
a plurality of sheets of paper each comprising a plurality of equally spaced holes adjacent one side, each hole including a slit with one open end extending to the edge of one side of the sheet of paper; and
a binding mechanism comprising a plurality of flexible C-shaped rings connected together, each C-shaped ring including a recess on an intermediate portion prior to binding the sheets of paper.

2. The spiral bound notebook of claim 1, wherein the width of the C-shaped ring is greater than that of the slit.
